(19) United States
(12) Patent Application Publication
(10) Pub. No.: US 2017/0118542 A1
(43) Pub. Date: Apr. 27, 2017

(54) SYSTEM AND METHOD FOR DATA RETRANSMISSION THROUGH RF OPAQUE BARRIERS

(71) Applicant: The Boeing Company, Chicago, IL (US)

(72) Inventors: Roger D. Bernhardt, O'Fallon, MO (US); Eric L. Nicks, Defiance, MO (US); Nail Hanov, St. Louis, MO (US)

(21) Appl. No.: 14/923,505

(22) Filed: Oct. 27, 2015

(51) Int. Cl. H04Q 9/00; G01H 17/00

(52) U.S. Cl. CPC H04Q 9/00; G01H 17/00; H04Q 2209/40

(57) ABSTRACT

A system and method for transmitting an information signal through a radio-frequency opaque barrier are disclosed. A transmitter is positioned on a first side of the barrier and a re-transmitter is positioned on a second side of the barrier. The transmitter includes a controller that modulates a received information signal with a carrier signal and forwards the modulated information signal to a vibration generator which converts the received electrical signal to a corresponding vibration signal. The re-transmitter includes an accelerometer that detects vibration signals and produces a corresponding electrical signal and a controller coupled to the accelerometer which receives the electrical signal from the accelerometer and demodulates the information signal included within the electrical signal received from the accelerometer. The transmitter may also include a vibration energy harvester which converts separate vibration signals received from the re-transmitter to energy that charges an energy storage device that powers the transmitter.

### FIELD

This disclosure relates generally to a system and method for data retransmission through radio-frequency (RF) opaque barriers.

### BACKGROUND

It is difficult to transmit RF information into or out of many types of metal or carbon fiber enclosures (or partial enclosures), such as a fuel tank (e.g., a complete enclosure) or an aircraft wheel well (e.g., a partial enclosure), because such the metal or carbon fiber wall forming such enclosure may act as a Faraday cage to block the transmission of RF signals into or out of that enclosure. In many cases, however, it is necessary to place an information source such as a sensor within such an enclosure, e.g., a sensor for measuring the amount of fuel remaining within a fuel tank. Although wires may be provided through an aperture in the metal or carbon fiber wall forming the enclosure, such apertures may provide a pathway for contamination or leakage and long runs may be needed for the wiring for each sensor. Furthermore, many common methods of transmitting data in low power and low data rate applications make use of the 2.4 to 2.4835 GHz frequency band (e.g., signals using the ZigBee protocol according to IEEE Standard 802.15.4). Signals transmitted in this frequency band have a wavelength of nearly five inches, which means that any metal or carbon fiber wall having openings which are only less than five inches in diameter will be RF opaque and prevent such type of signals from passing through such enclosure.

In addition, given the nature of such enclosures, which may be a fully-encased enclosure like a fuel tank or a partially-encased enclosure like an aircraft wheel well, power may be available on only one side of such enclosure. In the case of a fuel tank, for example, power wiring may be available or desired only on the outside the fuel tank. In the case of an aircraft wheel well, power wiring may be available or desired only within the wheel well. Since, as discussed above, it is preferable that no aperture be used through the metal or carbon fiber wall forming such an enclosure, power would thus be available only for a transmitter on one side of the wall but not a re-transmitter on the other side of the wall (or vice versa).

Accordingly, there is a need for a system and method of data transmission and/or retransmission which overcomes the problems recited above.

### SUMMARY

In a first aspect, a system for transmitting a first information signal through a radio-frequency opaque barrier is disclosed. The system includes a transmitter positioned on a first side of and in close proximity to the radio-frequency opaque barrier. The transmitter includes a vibration generator that converts an electrical signal received on an input to a corresponding vibration signal. The transmitter also includes a controller that is coupled to the input of the vibration generator and which receives a first information signal, modulates the first information signal with a first carrier signal to produce a modulated first information signal, and forwards the modulated first information signal to the input of the vibration generator. The system also include a re-transmitter positioned on a second side of and in close proximity to the radio-frequency opaque barrier. The second side of the radio-frequency opaque barrier is opposite the first side thereof. The re-transmitter includes an accelerometer that detects vibration signals and produces an electrical signal on an output corresponding to the detected vibration signals. The re-transmitter also includes a controller that is coupled to the output of the accelerometer and which receives the electrical signal from the output of the accelerometer and demodulates the first information signal included within the electrical signal received from the output of the accelerometer.

In a second aspect, a method for transmitting a first information signal through a radio-frequency opaque barrier is disclosed. A first information signal is modulated with a first carrier signal to produce a modulated first information signal in a first device positioned on a first side of and in close proximity to the radio-frequency opaque barrier. The modulated first information signal is converted to a corresponding first vibration signal in the first device. The first vibration signal is detected in a second device positioned on a second side of and in close proximity to the radio-frequency opaque barrier to produce a detected first vibration signal. The second side of the radio-frequency opaque barrier is opposite the first side thereof. The detected first vibration signal is converted to a first electrical signal in the second device. Finally, the first information signal included within the first electrical signal is demodulated in the second device.

In a third aspect, a system for transmitting energy through a radio-frequency opaque barrier is disclosed. The system includes a first device positioned on a first side of and in close proximity to the radio-frequency opaque barrier. The first device includes a vibration generator that converts an electrical signal received on an input to a corresponding vibration signal. The first device also includes a controller that is coupled to the input of the vibration generator and which forwards a predetermined signal to the input of the vibration generator. The system also include a second device positioned on a second side of and in close proximity to the radio-frequency opaque barrier. The second side of the radio-frequency opaque barrier is opposite the first side thereof The second device includes a vibration energy harvester device that generates an electrical signal on an output corresponding to detected vibration signals. The second device also includes an energy storage device coupled to the output of the vibration energy harvester device which is charged by the electrical signal received from the output of the vibration energy harvester device and supplies electrical power for the second device.

In a fourth aspect, a method for transmitting energy through a radio-frequency opaque barrier is disclosed. A predetermined electrical signal is converted to a corresponding vibration signal in a first device positioned on a first side of and in close proximity to the radio-frequency opaque barrier. The vibration signal is detected in a second device to produce a detected vibration signal and the detected vibration signal is converted to a corresponding electrical signal. The second device is positioned on a second side of and in close proximity to the radio-frequency opaque barrier. The second side of the radio-frequency opaque barrier is opposite the first side thereof. An energy storage device in the second device is charged using the corresponding electrical signal converted from the detected vibration signal.

The features, functions, and advantages that have been discussed can be achieved independently in various embodiments or may be combined in yet other embodiments, further details of which can be seen with reference to the following description and drawings.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is an illustration of a first embodiment of an energy scavenging data transmission system of the present disclosure;

FIG. 2 is a flowchart of a method of operation of the first embodiment of the energy scavenging data transmission system of the present disclosure;

FIG. 3 is an illustration of a second embodiment of an energy scavenging data transmission system of the present disclosure; and

FIG. 4 is a flowchart of a method of operation of the second embodiment of the energy scavenging data transmission system of the present disclosure.

Each figure shown in this disclosure shows a variation of an aspect of the embodiments presented, and only differences will be discussed in detail.

### DETAILED DESCRIPTION

In the present disclosure, like reference numbers refer to like elements throughout the drawings, which illustrate various exemplary embodiments of the present disclosure.

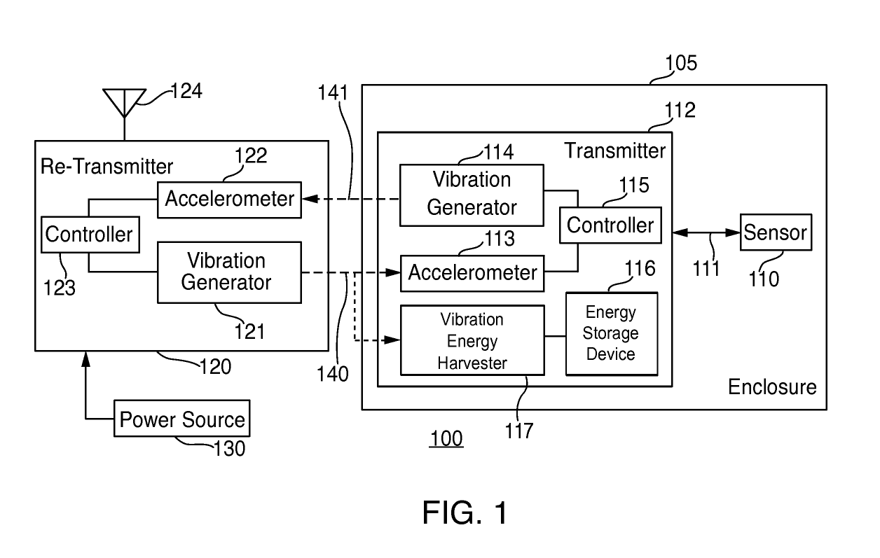

Referring now to FIG. 1, a first embodiment of an energy scavenging data transmission system 100 of the present disclosure is shown for use when power is available outside an enclosure 105 but not within such enclosure 105. In particular, an information source 110 is positioned within an enclosure 105 having an outer wall formed from a material which acts as a barrier to prevent any RF signals from passing through such outer wall into or out of enclosure 105. Information source 110 may be a sensor or any other type of source that provides information to be transmitted and may provide any type of output signal (e.g., analog or digital) to transmitter 112 via a link 111. The outer wall of enclosure 105 is formed from metal, carbon fiber or any other type of material which is opaque to RF signals. The data transmission system 100 of the present disclosure uses a paired transmitter 112 and re-transmitter 120 to forward information signals from information source 110 to a higher-level control system for further processing or usage while at the same time providing a source of power for transmitter 112. The information signals are converted from electrical energy to vibratory energy that can be transmitted through the outer wall of enclosure 105 from transmitter 112 to re-transmitter 120 when transmitter 112 and re-transmitter 120 are positioned on opposite sides of the outer wall of enclosure 105 but in close proximity to each other such that a vibration transmitted through the outer wall of enclosure 105 by one of transmitter 112 and re-transmitter 120 can be effectively sensed and acted upon by the other of transmitter 112 and re-transmitter 120.

Re-transmitter 120 is coupled to (and powered by) a power source 130 which is available outside of enclosure 105 but, due to the nature of enclosure 105 but which cannot be coupled into enclosure 105. Re-transmitter 120 includes a controller 123 that is coupled to a vibration generator 121 and to an accelerometer 122. Controller 123 is configured to generate a carrier signal that is supplied to vibration generator 121. Vibration generator 121 generates a vibratory signal 140 based on the carrier signal received from controller 123 which vibratory signal 140 is applied to the adjacent wall of enclosure 105. In a further embodiment where information signals are to be transmitted to transmitter 112 and/or information source 110, controller 123 may modulate such information signals with the carrier signal and provide the modulated signal to vibration generator 121. In this latter case, the vibratory signal 140 applied to the wall of enclosure 105 is based on the modulated signal. Accelerometer 122 is configured to detect a separate vibratory signal 141 (discussed below) and to convert such vibratory signal 141 into an electrical signal that is provided to controller 123. Controller 123, in turn, is configured to receive the converted electrical signal, to demodulate information signals included therein from the base carrier signal, and to forward the demodulated information signals to a higher level control system for further processing or usage. As one of ordinary skill in the art will readily recognize, re-transmitter 120 may forward the demodulated information signals wirelessly, via antenna 124, or alternatively via a wired interface (not shown in FIG. 1). The conversion of an electrical signal to a vibratory signal applied to one side of the wall of enclosure 105 permits such signals to be detected by on an opposite side of the wall of enclosure 105, even when such wall is formed from a material which blocks RF signals (i.e., formed from an RF opaque material).

Transmitter 112 includes a controller 115 that is coupled to a vibration generator 114 and to an accelerometer 113. Transmitter 112 also includes a vibration energy harvester device 117 that is coupled to an energy storage device 116 (e.g., a battery or a capacitor) and is configured to detect vibratory signal 140 (generated on an opposite side of the wall forming enclosure 105 by re-transmitter 120) and to convert such vibratory signal 141 into an electrical signal that is used to charge the energy storage device 116. Vibration energy harvester device 117 may convert vibrations to electrical energy using one or more of the following technologies: piezoelectric, electromagnetic, electrostatic (capacitive), and magnetostrictive. Energy storage device 116 is configured to provide all the power necessary to operate transmitter 112 and may also be used to power information source 110 in some cases. Accelerometer 113 is only necessary in the further embodiment where information signals are transmitted from re-transmitter 120 to transmitter 112. Accelerometer 113 is configured to detect vibratory signal 140 and to convert such vibratory signal 140 into an electrical signal that is provided to controller 115. Controller 115, in the further embodiment, is configured to monitor the converted vibratory signal, to demodulate any information signals included therein from the base carrier signal, and, in some cases, to forward such demodulated information signals to information source 110. The demodulated information signals may consist of configuration information for transmitter 112 and/or configuration information for information source 110. Controller 115 is also configured to receive an information signals from information source 110, to modulate such information signals with a carrier signal, and to forward the modulated information signals to vibration generator 114. In the event that transmitter 112 receives analog signals from information source 110, controller 115 is also configured to convert such analog signals to digital form as well. Vibration generator 114 converts the modulated information signals from an electrical signal to the vibratory signal 141 that is processed and forwarded by re-transmitter 120 on the opposite side of the wall forming enclosure 105.

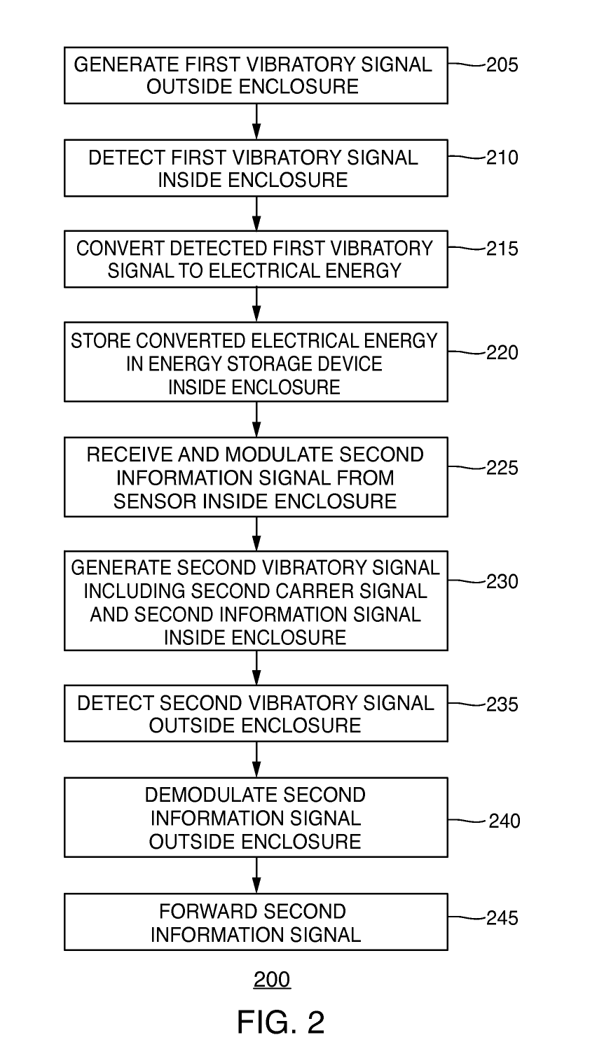

Referring now to FIG. 2, flowchart 200 shows the operation of system 100 in FIG. 1. In particular, at step 205, a first vibratory signal (e.g., signal 140 in FIG. 1) is generated outside of the enclosure by vibration generator 121. As discussed above, the first vibratory signal may consist of a carrier signal alone or in a further embodiment may consist of a carrier signal modulated with information signals. Next, at step 210, the first vibratory signal is detected inside the enclosure by vibration energy harvester device 117 and converted, at step 215, to an electrical signal. This converted vibratory signal, now in electrical form, is next coupled, at step 220, to charge an energy storage device (thereby storing the energy converted from vibratory form to electrical form). The energy storage device 116 in FIG. 1 is used to power transmitter 112. As discussed above, accelerometer 113 may convert the first vibratory signal into an electrical signal provided controller 115 and, if any information signals were previously modulated with the carrier signal in the vibratory signal, controller 115 may then demodulate such information signals for further processing. At step 225, controller 115 receives information signals from information source 110, and modulates such information signals with a carrier signal. The modulated signal created by controller 115 is then provided, at step 230, to vibration generator 114 to generate a second vibratory signal (e.g., vibratory signal 141 in FIG. 1) inside enclosure 105. The second vibratory signal is detected, at step 235, outside of enclosure 105 by accelerometer 122 in re-transmitter 120 and converted to an electrical signal. At step 240, controller 123 demodulates the information signals included within the converted second vibratory signal. Finally, at step 245, controller 123 forwards the demodulated information signals for further processing, e.g., via antenna 124 in FIG. 1. In this manner, information signals such as sensor data may be transmitted from a transmitter 112 inside an enclosure 105 through a wall of such enclosure to re-transmitter 120 outside enclosure 105 without requiring any aperture in such wall. Furthermore, since transmitter 112 uses the vibratory signals 140 to charge an internal energy storage device 116 which powers transmitter 112, transmitter 112 may transmit such information signals to re-transmitter 120 even though no local source of power is available to be directly wired to transmitter 112.

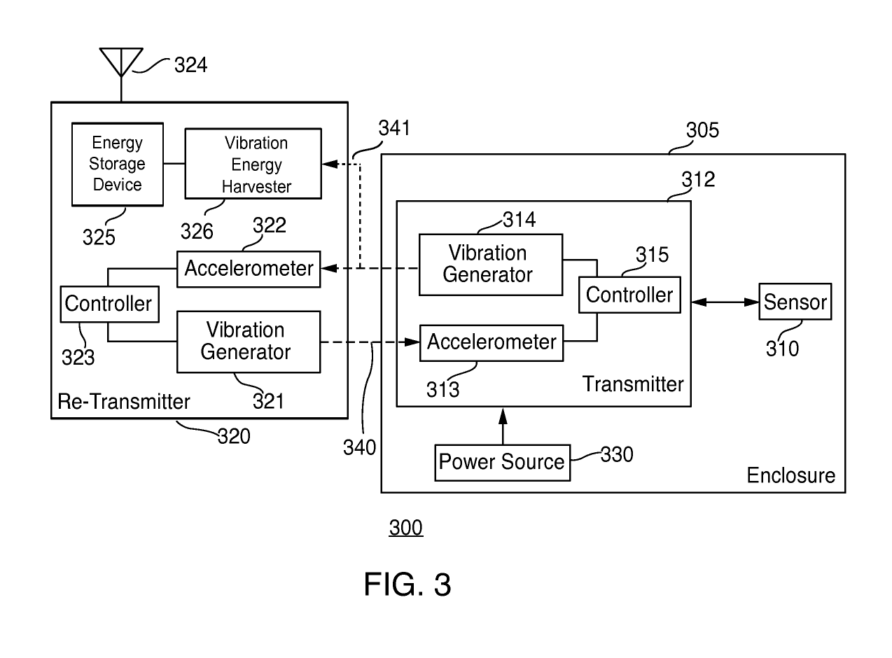

Referring now to FIG. 3, a second embodiment of an energy scavenging data transmission system 300 of the present disclosure is shown for use when power is available within an enclosure 305 but not immediately outside enclosure 305. In particular, an information source 310 is positioned within enclosure 305 having an outer wall formed from a material which acts as a barrier to prevent any RF signals from passing through such outer wall into or out of enclosure 305. Information source 310 may be a sensor or any other type of source that provides information to be transmitted and may provide any type of signals (e.g., analog or digital) to transmitter 312. The outer wall of enclosure 305 is formed from metal, carbon fiber or any other type of material which is opaque to RF signals. The data transmission system 300 of the present disclosure uses a paired transmitter 312 and re-transmitter 320 to forward information signals from information source 310 to a higher-level control system for further processing or usage while at the same time providing a source of power for re-transmitter 320. As with the first embodiment shown in FIG. 1, transmitter 312 is preferably positioned in close proximity to re-transmitter 320, but with transmitter 312 and re-transmitter 320 on opposite sides of the wall of enclosure 305.

Transmitter 312 is mounted inside of enclosure 305 and is coupled to (and powered by) a power source 330 which is available inside of enclosure 305. However, due to the nature of enclosure 305, power source 330 cannot be coupled to the point available immediately outside of enclosure 305 where re-transmitter 320 is mounted outside of the wall forming enclosure 305. Transmitter 312 includes a controller 315 that is coupled to a vibration generator 314 and may also be coupled to an accelerometer 322 in a further embodiment which allows information signals to be transferred from re-transmitter 320 to transmitter 312. In this further embodiment, accelerometer 313 is configured to detect a vibratory signal 340 (discussed below) and to convert such signal 340 into an electrical signal. Controller 315 receives the converted vibratory signal and demodulates the information signals included therein from a base carrier signal, and, if necessary, to forward such demodulated information signals to information source 310. The demodulated information signals may consist of configuration information for transmitter 312 and/or for information source 310. Controller 315 also receives information signals from information source 310, modulates such information signals with a carrier signal, and forwards the modulated information signals to vibration generator 314. In the event that transmitter 312 receives the information signals from information source 310 in analog form, controller 315 also to converts such analog signals to digital form as well. Vibration generator 314 converts the modulated information signals from an electrical signal to vibratory signal 341 that is applied to the inner wall of enclosure 305.

Re-transmitter 320 includes a controller 323 which is coupled to an accelerometer 322 and, in the further embodiment discussed above, to a vibration generator 321. Re-transmitter 320 also includes a vibration energy harvester device 326 which is coupled to an energy storage device 325 and is configured to detect the vibratory signal 341 (discussed above) and to convert such vibratory signal 341 into an electrical signal that is used to charge energy storage device 325. Vibration energy harvester device 117 may convert vibrations to electrical energy using one or more of the following technologies: piezoelectric, electromagnetic, electrostatic (capacitive), and magnetostrictive. Energy storage device 325 provides all the power necessary to operate re-transmitter 320. Accelerometer 322 is configured to detect vibratory signal 341 and to convert such vibratory signal 341 to an electrical signal that is provided to controller 323. Controller 323 is configured to receive the electrical signal output by accelerometer 322 and demodulate the information signals included within that signal from the base carrier signal, and to forward the demodulated information signals to a higher level control system for further processing or usage. As with system 100 in FIG. 1, re-transmitter 320 may forward the demodulated information signals wirelessly, via antenna 324, or via a wired interface, (not shown in FIG. 3). By converting the electrical signals from controller 315 inside enclosure to vibratory signals 341 permits such signals to be detected outside of the outer wall of enclosure 305, even when such wall is formed from a material such as metal or carbon fiber which blocks RF signals. In addition, by using the converted vibratory signals output by vibration energy harvester device 326 to charge energy storage device 325, re-transmitter 320 is able to operate in areas where there is no wired source of electrical power.

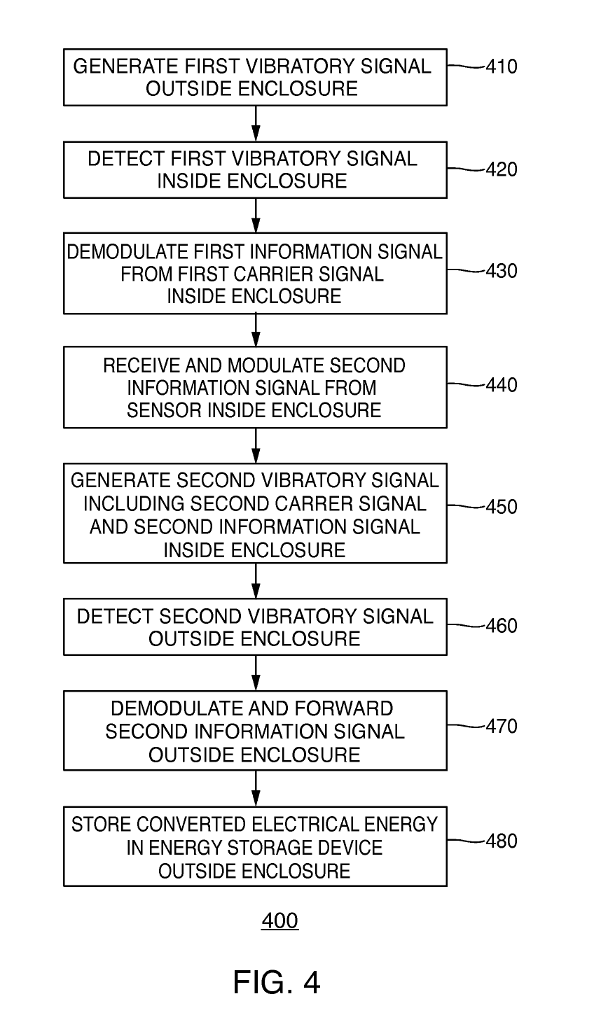

Referring now to FIG. 4, flowchart 400 shows the operation of system 300 in FIG. 3. First, at step 410, a first vibratory signal (e.g., signal 340 in FIG. 3) may be generated outside of the enclosure by vibration generator 321 consisting of a carrier signal modulated with first information signals. As discussed above, this step is only necessary in the further embodiment where information is to be transmitted to transmitter 312 for use by transmitter 312 and/or by information source 310 (e.g., configuration information). Next, at step 420, the first vibratory signal may be detected inside the enclosure by accelerometer 313 and then converted to an electrical signal. This converted vibratory signal, now in electrical form, next by be demodulated by controller 315 at step 430 for further processing. Steps 420 and 430 are also optional and only necessary in the further embodiment. At step 440, controller 315 receives information signals from information source 310, and modulates such information signals with a carrier signal. The modulated signal created by controller 315 is then provided, at step 450, to vibration generator 314 to generate a second vibratory signal (e.g., vibratory signal 341 in FIG. 3) inside enclosure 305. The second vibratory signal is detected, at step 460 and outside of enclosure 305, by accelerometer 322 in re-transmitter 320 and converted to an electrical signal. The second vibratory signal is also detected by vibration energy harvester device 326 and converted to an electrical signal. At step 470, controller 323 demodulates the information signals included within the converted second vibratory signal and forwards such information signals for further processing, e.g., via antenna 324 in FIG. 3. Finally, at step 480, the electrical signal from vibration energy harvester device 326 is applied to charge energy storage device 325. In this manner, information signals such as sensor data may be transmitted from inside an enclosure 305 through a wall of such enclosure to re-transmitter 320 outside enclosure 305 without requiring any aperture in such wall. Furthermore, since re-transmitter 320 uses the vibratory signals 341 to charge an internal energy storage device 325 which powers transmitter 320, re-transmitter 320 may receive and forward such information signals even though no local source of power is available to be directly wired to re-transmitter 320.

In the systems shown in FIGS. 1 and 3, an accelerometer generates an electrical signal based on detected vibratory signals which is used to decode information signals, while a separate vibration energy harvester converts the same vibratory signals to electrical signals used to charge an energy storage device such as a battery or capacitor. In some cases, depending on the type of vibration energy harvester device employed, it may be possible to omit the separate accelerometer and use the output of the vibration energy harvester both as a signal applied to the controller to decode information signals and as a signal used to charge an energy storage device.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A system for transmitting a first information signal through a radio-frequency opaque barrier, comprising:
a transmitter positioned on a first side of and in close proximity to the radio-frequency opaque barrier, the transmitter comprising:
a vibration generator that converts an electrical signal received on an input to a corresponding vibration signal, and
a controller that is coupled to the input of the vibration generator and which receives a first information signal, modulates the first information signal with a first carrier signal to produce a modulated first information signal, and forwards the modulated first information signal to the input of the vibration generator; and
a re-transmitter positioned on a second side of and in close proximity to the radio-frequency opaque barrier, the second side of the radio-frequency opaque barrier opposite the first side thereof, the re-transmitter comprising:
an accelerometer that detects vibration signals and produces an electrical signal on an output corresponding to the detected vibration signals; and
a controller that is coupled to the output of the accelerometer and which receives the electrical signal from the output of the accelerometer and demodulates the first information signal included within the electrical signal received from the output of the accelerometer.

2. The system of claim 1, wherein the controller in the re-transmitter also forwards the demodulated first information signal on an output.

3. The system of claim 1, wherein:
the re-transmitter further comprises a vibration generator that converts an electrical signal received on an input to a corresponding vibration signal;
the controller in the re-transmitter outputs a second carrier signal on an output coupled to the input of the vibration generator;
the transmitter further comprises:
a vibration energy harvester device that generates an electrical signal on an output corresponding to detected vibration signals; and
an energy storage device coupled to the output of the vibration energy harvester device which is charged by the electrical signal received from the output of the vibration energy harvester device and supplies electrical power for the transmitter.

4. The system of claim 3, wherein the controller in the re-transmitter also forwards the demodulated first information signal on an output.

5. The system of claim 1, wherein:
the re-transmitter further comprises a vibration generator that receives an electrical signal on an input and converts the received electrical signal to a corresponding vibration signal;
the controller in the re-transmitter outputs a signal comprised of a second information signal modulated with a second carrier signal on an output coupled to the input of the vibration generator;
the transmitter further comprises an accelerometer that detects vibration signals and produces an electrical signal on an output corresponding to the detected vibration signals; and
the controller in the transmitter is coupled to the output of the accelerometer and which receives the electrical signal from the output of the accelerometer and demodulates the second information signal included within the electrical signal received from the output of the accelerometer.

6. The system of claim 5, wherein the controller in the re-transmitter also forwards the demodulated first information signal on an output.

7. The system of claim 5, wherein the transmitter further comprises:
a vibration energy harvester device that generates an electrical signal on an output corresponding to detected vibration signals; and
an energy storage device coupled to the output of the vibration energy harvester device which is charged by the electrical signal received from the output of the vibration energy harvester device and supplies electrical power for the re-transmitter.

8. The system of claim 7, wherein the controller in the re-transmitter also forwards the demodulated first information signal on an output.

9. The system of claim 1, wherein the re-transmitter further comprises:
a vibration energy harvester device that generates an electrical signal on an output corresponding to detected vibration signals, and
an energy storage device coupled to the output of the vibration energy harvester device which is charged by the electrical signal received from the output of the vibration energy harvester device and supplies electrical power for the transmitter.

10. The system of claim 9, wherein the controller in the re-transmitter also forwards the demodulated first information signal on an output.

11. The system of claim 9, wherein
the re-transmitter further comprises a vibration generator that receives an electrical signal on an input and converts the received electrical signal to a corresponding vibration signal;
the controller in the re-transmitter has an output coupled to the input of the vibration generator and outputs a signal comprised of a second information signal modulated with a second carrier signal on the output;
the re-transmitter further comprises an accelerometer that detects vibration signals and to produce an electrical signal on an output corresponding to the detected vibration signals; and
the controller in the transmitter that is coupled to the output of the accelerometer and which receives the electrical signal from the output of the accelerometer and demodulates the second information signal included within the electrical signal received from the output of the accelerometer.

12. The system of claim 11, wherein the controller in the re-transmitter also forwards the demodulated first information signal on an output.

13. A method for transmitting a first information signal through a radio-frequency opaque barrier, comprising the steps of:
modulating a first information signal with a first carrier signal to produce a modulated first information signal in a first device positioned on a first side of and in close proximity to the radio-frequency opaque barrier;
converting the modulated first information signal to a corresponding first vibration signal in the first device;
detecting the first vibration signal in a second device positioned on a second side of and in close proximity to the radio-frequency opaque barrier to produce a detected first vibration signal, the second side of the radio-frequency opaque barrier opposite the first side thereof;
converting the detected first vibration signal to a first electrical signal in the second device; and
demodulating the first information signal included within the first electrical signal in the second device.

14. The method of claim 13, further comprising the steps of:
converting a predetermined electrical signal to a corresponding second vibration signal in the second device;
detecting the second vibration signal to produce a detected second vibration signal and converting the detected second vibration signal to a corresponding second electrical signal in the first device; and
charging an energy storage device in the first device using the second electrical signal.

15. The method of claim 13, further comprising the steps of:
converting a predetermined electrical signal comprising a second information signal modulated with a second carrier signal to a corresponding second vibration signal in the second device;
detecting the second vibration signal to produce a detected second vibration signal and converting the detected second vibration signal to a corresponding second electrical signal in the first device; and
demodulating the second information signal included within the second electrical signal in the first device.

16. The method of claim 15, further comprising the steps of:
detecting the second vibration signal in the first device to produce a detected second vibration signal and converting the detected second vibration signal to a corresponding third electrical signal; and
charging an energy storage device in the first device using the third electrical signal.

17. The method of claim 13, further comprising the steps of:
detecting the first vibration signal in the second device to produce a detected first vibration signal and converting the detected first vibration signal to a corresponding second electrical signal; and
charging an energy storage device in the second device using the second electrical signal.

18. The method of claim 17, further comprising the steps of:
converting a predetermined electrical signal comprising a second information signal modulated with a second carrier signal to a corresponding second vibration signal in the second device;
detecting the second vibration signal to produce a detected second vibration signal and converting the detected second vibration signal to a corresponding third electrical signal in the first device; and
demodulating the second information signal included within the third electrical signal in the first device.

19. A system for transmitting energy through a radio-frequency opaque barrier, comprising:
a first device positioned on a first side of and in close proximity to the radio-frequency opaque barrier, the first device comprising:
a vibration generator that converts an electrical signal received on an input to a corresponding vibration signal, and
a controller that is coupled to the input of the vibration generator and which forwards a predetermined signal to the input of the vibration generator; and
a second device positioned on a second side of and in close proximity to the radio-frequency opaque barrier, the second side of the radio-frequency opaque barrier opposite the first side thereof, the second device comprising:
a vibration energy harvester device that generates an electrical signal on an output corresponding to detected vibration signals; and
an energy storage device coupled to the output of the vibration energy harvester device which is charged by the electrical signal received from the output of the vibration energy harvester device and supplies electrical power for the second device.

20. A method for transmitting energy through a radio-frequency opaque barrier, comprising the steps of:
converting a predetermined electrical signal to a corresponding vibration signal in a first device positioned on a first side of and in close proximity to the radio-frequency opaque barrier;
detecting the vibration signal in a second device to produce a detected vibration signal and converting the detected vibration signal to a corresponding electrical signal, the second device positioned on a second side of and in close proximity to the radio-frequency opaque barrier, the second side of the radio-frequency opaque barrier opposite the first side thereof; and
charging an energy storage device in the second device using the corresponding electrical signal converted from the detected vibration signal.
